(19) United States
(12) Patent Application Publication
(10) Pub. No.: US 2011/0037839 A1
(43) Pub. Date: Feb. 17, 2011

(54) INDUSTRIAL ROBOT, AND METHODS FOR DETERMINING THE POSITION OF AN INDUSTRIAL ROBOT RELATIVE TO AN OBJECT

(75) Inventors: Johannes Kurth, Augsburg (DE); Andreas Sedlmayr, Furstenfeldbruck (DE)

Correspondence Address: SCHIFF HARDIN, LLP;PATENT DEPARTMENT, 233 S. Wacker Drive-Suite 6600, CHICAGO, IL, 60606-6473, US

(73) Assignee: KAKA Roboter GmbH, Augsburg (DE)

(21) Appl. No.: 12/528,549

(22) PCT Filed: Jan. 25, 2008
(86) PCT No.: PCT/EP2008/050849

§ 371 Date: Nov. 5, 2010

(30) Foreign Application Priority Data
Feb. 28, 2007 (DE) 10 2007 009 851.2

(51) Int. Cl. H04N 7/18

(52) U.S. Cl. 348/61; 348/E07.085

(57) ABSTRACT

The invention relates to methods for determining the position of an industrial robot (1, 81) relative to an object (M, 82) as well as correspondingly equipped industrial robots (1, 81). In one of said methods, a 2D camera (17) that is mounted on the industrial robot (1) is moved into at least two different positions, an image (20, 30) of an object (M) that is stationary relative to the surroundings of the industrial robot (1) is generated in each of the positions, the images (20, 30) are displayed, a graphic model (16) of the object (M) is superimposed on the images (20, 30), points (21A, 22A, 31A, 32A) of the graphic model (16) are manually assigned to corresponding points (21A, 21B, 31A, 31B) in the two images (20, 30), and the position of the industrial robot (1) relative to the object (M) is determined on the basis of the points (21A, 22A, 31A, 32A) of the model (16) assigned to the corresponding points (21B, 22B, 31B, 32B).

The invention concerns industrial robots and methods to determine the location of an industrial robot relative to an object.

DE 102 49 786 A1 discloses a method for referencing a robot relative to a patient of whom an image is respectively generated from at least two positions with at least one camera attached to the robot. Within the scope of this method, a reference point of the patient is selected in one of the images, a relation of the selected reference point in three-dimensional space is established via position data of the reference point of both images, and the position of the robot relative to the patient is correlated.

In order to determine the location of an industrial robot relative to an object, WO 2004/071717 A1 discloses registering and storing a plurality of measurement points on the surface of the object, determining the orientation and the position of a CAD model of the object relative to a coordinate system of the industrial robot and establishing a resulting deviation for at least some of the measurement points and the corresponding points in the model. For the registration of the measurement points, the industrial robot approaches the measurement points with a measurement prod which comprises, for example, a no-contact sensor.

A determination of the location of an industrial robot relative to an object that is based on the registration of the measurement points on the surface of the object can, however, be relatively difficult if, for example, necessary measurement points are relatively difficult to reach or cannot even be reached at all with the industrial robot.

The object of the invention is therefore to specify a simpler method to determine the location of an industrial robot relative to an object, and a corresponding industrial robot.

The object of the invention is achieved via a method to determine the location of an industrial robot relative to an object, possessing the following method steps:
movement of a 2D camera attached to an industrial robot into at least two different positions by means of said industrial robot,
in each of the positions, generation by means of the camera of a two-dimensional image data set associated with an image of an object, wherein the object is immobile relative to the environment of the industrial robot,
display of the images by means of a display device and superimposition of a graphical model in the displayed images, wherein the graphical model is at least a partial model of the object and is described in coordinates relative to coordinates of the industrial robot,
manual association of model points of the graphical model with corresponding image points in the two images and
determination of the location of the industrial robot relative to the object based on the associated model points of the model at the corresponding image points in the images, the positions of the camera that are associated with the images and the position of the camera relative to the industrial robot.

In the processing of the object (for example a work piece) with the industrial robot, knowledge of the location of the object relative to the industrial robot (for example relative to its base point) is necessary. The location of the industrial robot relative to the object is in particular its position and orientation relative to the industrial robot [sic].

In order to determine this location, according to the invention respective images of the object are generated from at least two different positions of the industrial robot, i.e. at least two different image data sets associated with the object are generated by means of the 2D camera. The images can only partially or also completely image the object. Furthermore, more than two images of the object can also be generated with the camera from different positions. Via the use of only one 2D camera (which can be a CCD sensor or a digital camera, for example), the method according to the invention can be implemented relatively cheaply.

The 2D camera is attached to an industrial robot (for example on the flange or an axle of the industrial robot) and is accordingly brought into the at least two positions via movement of the industrial robot, i.e. via movement of its axles.

The placement of the camera on the industrial robot is known, such that the coordinates of the camera relative to the industrial robot are likewise known or can be calculated based on the axle positions of the axles of the industrial robot at the positions.

If the image data sets are generated, the corresponding images are displayed with the display device and the graphical model of the object is overlaid in the images. It is thereby possible that initially only one of the images is displayed and the model is overlaid in this image. However, it is also possible to display all images simultaneously and to overlay the model in all images.

The graphical model but does not necessarily need to be a complete model of the object. The model can also be only a partial model of the object.

The model can also be what is known as a graphical wire frame model or a partial graphical wire frame model of the object. A wire frame model (which is designated in English as a “wireframe”) in particular models three-dimensional objects in a CAD, wherein surfaces of the object in the wire frame model are represented as lines, and it is also possible in particular to visualize only edges. If the wire frame model is only a partial wire frame model, this then comprises only some of these lines, for example, and in particular particularly prominent lines or corners of the object.

According to the invention, manual model points of the model are subsequently associated with corresponding image points in the images.

Furthermore, these same model points of the model do not need to be associated with corresponding image points in both images.

The association of the model points and image points can, for example, ensue by means of a pointer device with which, for example, a vertex of the wire frame or partial wire frame model is selected. The selection ensues by means of the method known as “object capture” in CAD engineering, for example. The pointer device is a computer mouse, for example.

If the model point in the model is selected, this can then be manually dragged with the pointer device to the corresponding image point in one of the images. A manual action has the advantage that a person can in particular relatively easily recognize vertices shown in the images, for example using tapering edges or shadows. The possibility of enlarging an image section comprising the relevant image point or of an emphasis of image edges can support the precision of the association, whereby a possible occurring error in the association can be reduced.

The association of the model points and image point can also ensue with what is known as a six-dimensional mouse (space mouse). A space mouse is an input device with which six degrees of freedom can be modified simultaneously. It can be used in the association of the model points and image points in order, for example, to shift the location of the overlaid model relative to the image of the object until a desired coverage is achieved.

For the determination of the location of the object relative to the industrial robot, at least four different image points are necessary if the industrial robot has six degrees of freedom and the distances between the camera and the object at the two positions are not known, which will normally be the case. However, it is necessary to associate at least two different image points in at least two images with the model, wherein it is preferred to use an identical number of image points per image. More than the minimum mathematically necessary number of point associations can be made. If an operator communicates the required precision of the relative location of the object that is to be determined, with every additional point association it can be checked and registered until the required precision can be satisfied.

If sufficient model points and image points are associated, the location of the industrial robot can then be determined relative to the object since the positions of the camera and the position of the camera relative to the industrial robot are additionally known.

In an industrial robot with six degrees of freedom and given a lack of knowledge of the distance between the object and the camera, as already mentioned at least four associated image points are required that are distributed across the at least two images.

The location of the object relative to the industrial robot can then, for example, ensue by solving a regular or overdetermined equation system with full rank) by means of which what is known as a 6 DOF (“6 degrees of freedom”) transformation can be implemented. The model in the images can then also be displayed corresponding to the solved transformation.

If the number of associated points is not yet sufficient, the model can then be positioned in the images such that it comes to cover the associated points.

The transformation can ensue as follows, for example:

A selected image point Bᵢ can be represented as follows in homogeneous coordinate notation in a two-dimensional coordinate system of the camera:

$${B}_{i} = ( \begin{matrix}x \\ y \\ 0 \\ 1\end{matrix} )$$

The model point Pᵢ corresponding to this in the three-dimensional coordinate system of the model can be represented as follows in homogeneous coordinate notation:

$${P}_{i} = ( \begin{matrix}x \\ y \\ z \\ 1\end{matrix} )$$

The transformation matrix for a transformation from a coordinate system of the object into the coordinate system of the image in the i-th position of the camera reads:
Tᵢ

for example, if images are acquired from two positions, then the transformation matrix for the transformation from the coordinate system of the object into the coordinate system of the image in the 1st position reads

and the transformation matrix for the transformation from the coordinate system of the object into the coordinate system of the image in the 2nd position reads
T₂

The projection matrix for the projection of the coordinates of the i-th image point onto the coordinates of the model reads as follows, for example:

$${Proj}_{i} = [ \begin{matrix}1 & 0 & 0 & 0 \\ 0 & 1 & 0 & 0 \\ 0 & 0 & 1 & 0 \\ 0 & 0 & 1 / {d}_{i} & 0\end{matrix} ] ,$$

wherein dᵢ is a camera position-dependent distance parameter of the position of the camera at the i-th position. The distance parameter dᵢ corresponds, for example, to the distance between the focal point of the camera and the projection plane (image plane) of the perspective projection as it is described, for example, by James D. Foley et. al. in “Computer Graphics Principles and Practice”, Addison-Wesley Publishing Company, Reading, Mass., 1992, P. 255.

A normalization of the homogeneous coordinate can ensue for the further calculation of the location of the object relative to the industrial robot, such that the distance parameter dᵢ of the projection matrix Projᵢ receives the value “1”. This can be mathematically expressed as follows:

$$norm ( \vec{k} ) = \frac{\vec{k}}{{k}_{4}}$$

wherein \vec{k} is the vector of the fourth line of the projection matrix Projᵢ and k₄ corresponds to the distance parameter dᵢ.

The location of the object relative to the industrial robot can ultimately be implemented [sic] by means of optimization, in particular nonlinear optimization such as, for example, Gauss Newton or Levenberg Marquardt [sic]. For example, the following objective function f(x) can be set up for the nonlinear optimization:

$$f ( x ) = {\sum }_{i} ‖ {B}_{i} - norm ( {Proj}_{i} \cdot {T}_{i} ( x ) \cdot {P}_{i} ) ‖$$

with the parameter vector x

$$x = ( \begin{matrix}{T}_{x} \\ {T}_{y} \\ {T}_{z} \\ {R}_{x} \\ {R}_{y} \\ {R}_{z}\end{matrix} )$$

Additional unknown parameters are the distance parameters dᵢ.

According to a variant of the method according to the invention, this possesses the following additional method steps:
manual association of a first model point of the model points of the model with a corresponding first image point of one of the two images,
displacement of the model overlaid in the images so that the first model point and the first image point correspond,
locking the two corresponding first model and image points,
manual association of a second model point of the model points of the model with a corresponding second image point of one of the two images,
displacement of the model overlaid in the images so that the second model point and the second image point likewise correspond,
locking the two corresponding second model and image points,
manual association of additional individual model points of the model with corresponding image points in the images until the location of the industrial robot relative to the object can be determined.

According to this variant of the method according to the invention, the two first points are initially associated and the model displayed in the image is in particular subsequently, automatically shifted such that the two first points coincide. A displacement is in particular a translational displacement, a tilting or a rotation of the overlaid model. Even if the manual association ensues only in one of the images, an in particular automatic displacement of the overlaid model can ensue in all images. A partial location determination of the model can also ensue via the displacement, for example via a partial calculation of the transformation described above.

After the displacement of the model in the image or, respectively, the images, the two coinciding points are locked. Via the locking it is in particular achieved that the overlaid model can at most still be rotated or tilted on the locked points in the image.

The next point pair (thus a model point of the displayed model and the corresponding image point in one of the images) is subsequently selected, and the overlaid model is displaced such that this point pair also corresponds. This point pair is again locked. Here it can also be provided to displace the overlaid model in all images.

The association of point pairs is continued until the location of the industrial robot relative to the object can be determined. For example, this is possible when the overlaid model corresponds in all images of the object.

According to one embodiment of the method according to the invention, an automatic size adaptation of the overlaid model is implemented based on a manual association of one of the image points. This is necessary when the measurements of the overlaid model differ from the measurements of the imaged object, which will normally be the case.

In addition to the association of points, lines and/or surfaces of the model can also be manually associated with corresponding lines or, respectively, surfaces in at least one of the images. Alternatively, it is also possible to manually associate lines and/or surfaces of the model with corresponding lines or, respectively, surfaces in the images instead of points.

In contrast to the point association, given line association other degrees of freedom are established (rotation in the image plane, translation along displacement vector). In contrast to this, in point association two degrees of freedom are established (translation in x and y of the image coordinates).

Although degrees of freedom are no longer established in the line association, depending on the shape and view of the object (for example of the work piece) it is sometimes more advantageous to bring lines into congruence as individual points.

A lin [sic] (for example an edge) can be selected (for example in a model, in particular in a wire frame model or in a partial wire frame model) with the pointer device using the “object capture” method known from the CAD world. The selected edge can then be dragged onto the corresponding edge in the image. The edges in the image are identified with the image data processing “edge extraction” method, for example. If the pointer of the pointer device is brought into proximity with such an edge, the “snap-to-line” function known from the CAD world can assist the operator.

According to a further embodiment of the method according to the invention, it is not the 2D camera that is attached to the industrial robot but rather the object. The 2D camera is then immobile relative to a base coordinate system of the industrial robot and the object is moved into at least two different positions by means of the industrial robot. The location of the industrial robot relative to the object can then be determined based on the associated model points of the model relative to the corresponding image points in the images, the positions of the object associated with the images and the position of the camera relative to the base coordinate system of the industrial robot. Alternatively, the location of the flange of the industrial robot relative to the object can also be determined. Since the location of the flange relative to the base coordinate system of the industrial robot is known, the location of the industrial robot relative to the object can be determined via the location of the flange relative to the object.

According to one embodiment of the method according to the invention, the object is arranged on a table plate that can be moved relative to a reference point that is immobile relative to the environment of the industrial robot. The camera is attached to the industrial robot or is set up so as to be immobile relative to a base coordinate system of the industrial robot. The two positions for which the two two-dimensional image data sets are generated result via movement of the industrial robot or the table plate. In order to determine the location of the object relative to the industrial robot, the location of the object relative to the table plate is initially determined based on the model points of the model associated with the corresponding image points in the images, the positions of the table plate associated with the images relative to the industrial robot and the position of the camera relative to the industrial robot.

Advantages of the method according to the invention can be the following, among others:

Intuitive, interactive, flexible, semi-automatic calibration method, relatively independent of the shape of the object, for location determination using a simple 2D camera.

The method according to the invention does not require any teaching of object features as is necessary in conventional image processing solutions. This is primarily connected with a disproportionately large time cost in small series production of many different parts.

The method according to the invention utilizes the human spatial association capability about the object to be calibrated. With the aid of a graphical interface for user interaction, the operator can communicate his knowledge about the 3D geometry of the object to the algorithm for calculation of the transformation.

The object is also achieved via an industrial robot possessing
multiple axles movable by means of actuators,
a control device to activate the actuators,
a 2D camera to generate a two-dimensional image data set, wherein the camera is attached at the industrial robot such that it can be moved by the industrial robot,
a graphical model stored in the control device, which graphical model is at least a partial model of an object and is described in coordinates relative to coordinates of the industrial robot,
a display device to display images associated with image data sets generated with the camera, and to overlay the model in the displayed images and
an input device for manual association of points of the graphical model with points in the images,

wherein the industrial robot is set up such that the method according to the invention can be implemented with it in order to determine the location of the object relative to the industrial robot when the object is arranged immobile relative to the environment of the industrial robot or on a table plate that can be moved relative to a reference point that is immobile relative to the environment of the industrial robot.

The object of the invention is also achieved via an industrial robot possessing
multiple axles movable by means of actuators,
a control device to activate the actuators,
a 2D camera to generate a two-dimensional image data set, wherein the camera is immobile relative to a base coordinate system of the industrial robot,
a graphical model stored in the control device, which graphical model is at least a partial model of an object and is described in coordinates relative to coordinates of the industrial robot,
a display device to display images associated with image data sets generated with the camera, and to overlay the model in the displayed images and
an input device for manual association of points of the graphical model with points in the images,

wherein the industrial robot is set up such that the method according to the invention can be implemented with it in order to determine the location of the physical object relative to the industrial robot when the object is arranged immobile relative to the industrial robot when the physical object is attached to the industrial robot and can be moved by means of this.

The input device is, for example, a pointer device or a space mouse.

Exemplary embodiments of the invention are shown by way of example in the attached, schematic drawings. Shown are:

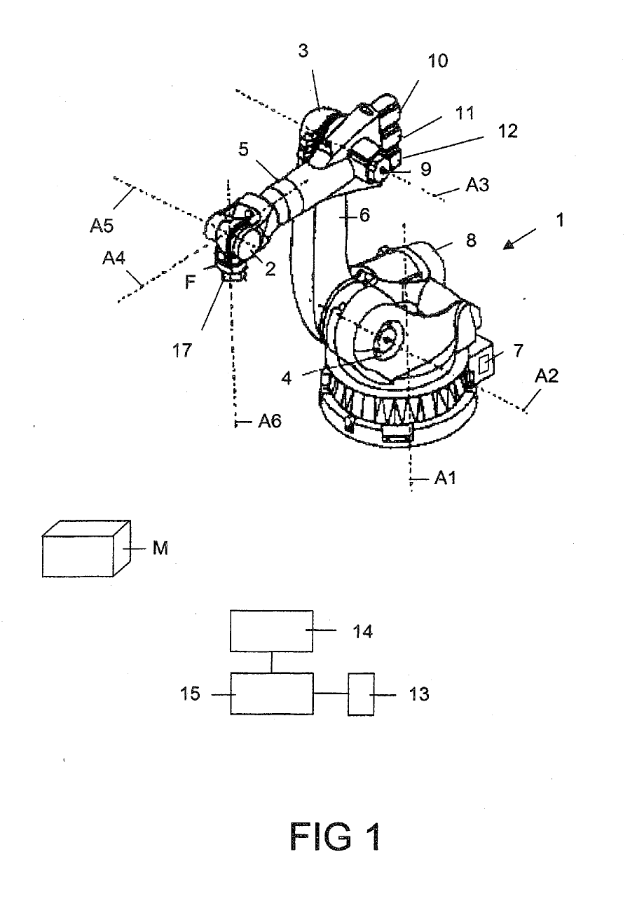

FIG. 1 an industrial robot and a motor block,

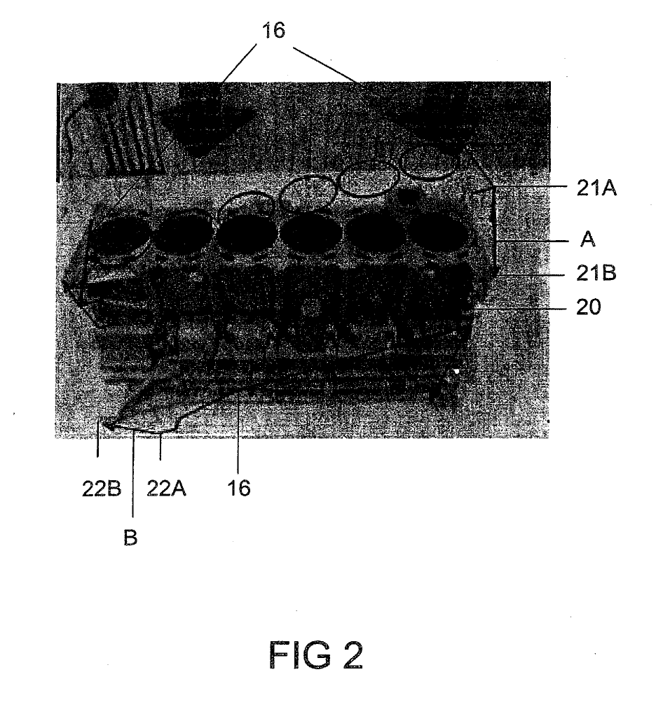

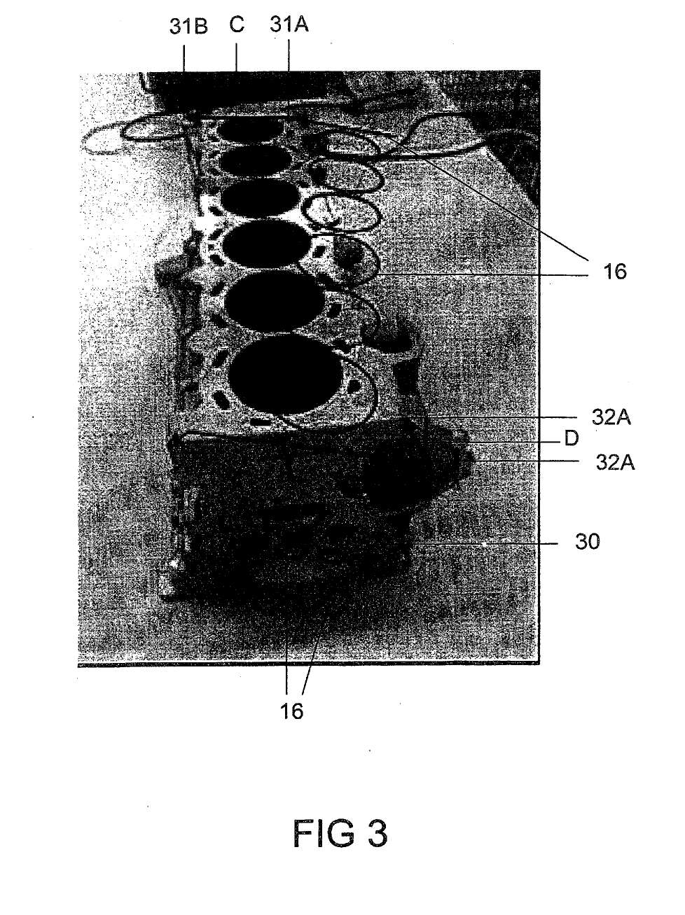

FIGS. 2, 3 images of the motor block of FIG. 1,

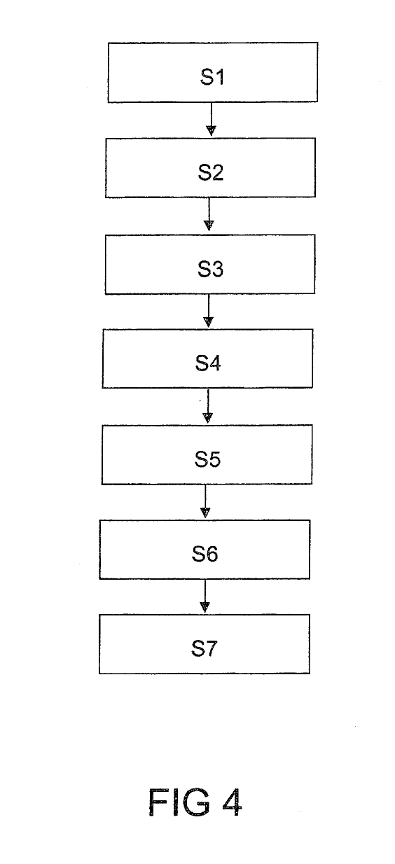

FIG. 4 a flow chart,

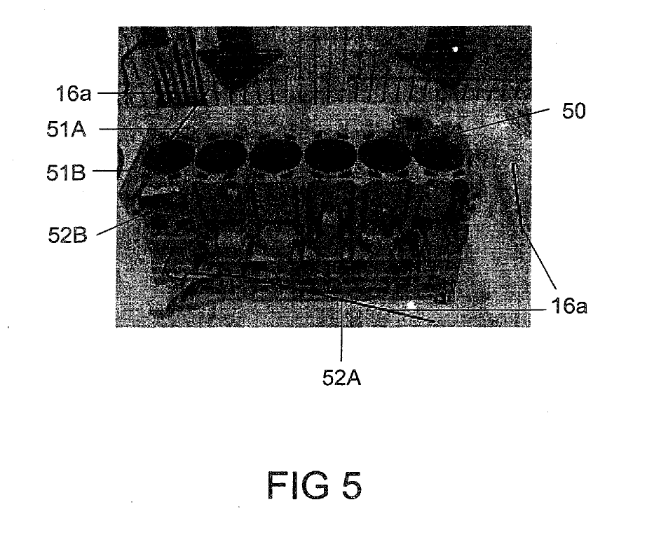

FIGS. 5-7 additional images of the motor block of FIG. 1 and

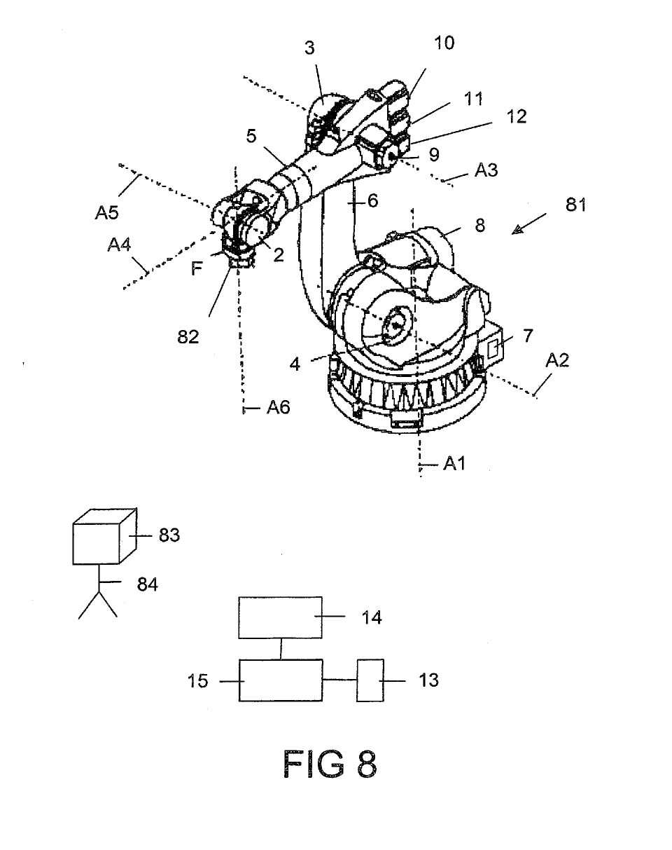

FIGS. 8-10 additional industrial robots.

FIG. 1 shows a 6-axle industrial robot 1 with kinematics for movements of the six degrees of freedom and an object that is immobile relative to the environment of the industrial robot 1, which object is a motor block M in the case of the present exemplary embodiment.

The industrial robot 1 possesses (in a generally known manner) articulations 2-4, levers 5-6, six movement axles A1-A6 and a flange F. Each of the axles A1-A6 is moved by an actuator.

In the case of the present exemplary embodiment, the actuators are electrical actuators that respective possess an electrical motor 7-12. The motor 7 thereby moves the axle A1, the motor 8 moves the axle A2, the motor 9 moves the axle A3 and the motors 10-12 move the axles A4-A6 via gearing (not shown in detail in FIG. 1 but generally known to the man skilled in the art).

The electrical actuators or, respectively, the electrical motors 7-12 are connected (not shown in detail) with a control computer 15 on which a computer program that is suitable and known in principle to the man skilled in the art runs, which computer program controls the movements of the industrial robot 1. The term “control” should also comprise a regulation in this context.

In the case of the present exemplary embodiment, a CAD (Computer Aided Design) model 16 of the motor block M that is shown in FIGS. 2 and 3 is stored in the control computer 15. In the case of the present exemplary embodiment, the model 16 was created in a generally known manner by means of a CAD program and can be viewed by a person (not shown in detail in Figures) by means of a monitor 14 connected with the control computer 15.

In the case of the present exemplary embodiment, the model 16 is a partial model of the motor block M, and specifically a partial wire frame model. A wire frame model (designated in English as a “wireframe” model) in particular models three-dimensional objects in a CAD, such as the motor block M in the case of the present exemplary embodiment. Surfaces of the object are thereby represented as lines in a wire frame model, wherein in the present exemplary embodiment only a few vertices and edges of the motor block M are modeled by means of the model 16.

For the processing of the motor block M by means of the industrial robot 1, the industrial robot 1 must be calibrated relative to the motor block M so that the coordinate system of the model 16 coincides in relation to the coordinate system of the motor block M, meaning that the location of the motor block M is determined relative to the industrial robot 1.

The determination of the location of the motor block M relative to the industrial robot 1 is illustrated by means of a flow chart shown in FIG. 4.

In the case of the present exemplary embodiment, a 2D camera 17 connected (in a manner not shown) with the control computer 15 is attached to the flange F of the industrial robot 1. The 2D camera 17 is, for example, a CCD sensor or a generally known digital camera. The position of the camera 17 at the industrial robot 1 is known.

It is the purpose of the camera 17 to generate at least two 2D images of the motor block M from two different positions. The at least two positions are realized in that the industrial robot 1 moves the camera 17 into the two different positions in that its axles A1-A6 are moved in a generally known manner (Step S1 of the flow diagram of FIG. 4).

If the camera 17 is located in the respective position, it respectively generates an image data set whose associated images 20, 30 are shown in FIGS. 2 and 3 (Step S2 of the flow chart). The images 20, 30 are images of the motor block M, wherein in the case of the present exemplary embodiment the entire motor block M is essentially imaged in each of the images 20, 30. However, this is not absolutely necessary; in at least one of the images, only a portion of the motor block M can also be imaged.

After the images 20, 30 are generated, in the case of the present exemplary embodiment they are simultaneously displayed on the monitor 14. At the same time, the model 16 is overlaid in each of the images 20, 30 (Step S3 of the flow diagram).

A person (not shown in Figures) subsequently selects a point 21A of the model 16 by means of an input device of the control computer 15 (Step S4 of the flow chart).

In the case of the present exemplary embodiment, the input device is a pointer device in the form of a computer mouse 13, and the point 21A of the model 16 represents an edge of the motor block M. In the case of the present exemplary embodiment, the point 21A is selected with what is known as the “object capture” method known from computer graphics. The person subsequently selects the point 21B corresponding to the point 21A in the first image 20 of the motor block M.

In the case of the present exemplary embodiment, after the association of the point pair comprising the points 21A, 21B a computer program running on the control computer 15 automatically moves the model 16 overlaid in the images 20, 30 such that the points 21A, 21B coincide in both images 20, 30, which is indicated with an arrow A. The corresponding points 21A, 21B are subsequently locked (Step S5 of the flow chart).

Due to the association of the point pair comprising the points 21A, 21B and the movement of the model 16 in the images 20, 30 such that the two points 21A, 21B overlap, a partial calculation to determine the location of the motor block M relative to the industrial robot 1 already results.

The person subsequently selects an additional point 22A of the model 16 and a point 22A in the first image 20 corresponding to the selected point 22A of the model 16. The computer program running on the control computer 15 thereupon again automatically moves the model 16 overlaid in the images 20, 30 such that the points 22A, 22B in both images 20, 30 overlap, which is indicated with an arrow B. The model 16 overlaid in the images 20, 30 is thus now shifted such that the points 21A and 21B and the points 22A and 22B overlap and are also locked (Step S6 of the flow chart).

The person subsequently selects additional corresponding points 31A, 31B and 32A, 32B in the second image 30. The computer program running on the control computer 15 thereupon again automatically moves the model 16 overlaid in the images 20, 30 such that the point pair comprising the points 31A and 31B and the point pair comprising the points 32A and 32B also overlap, which is indicated with arrows C, D.

Furthermore, in the case of the present exemplary embodiment the computer program running on the control computer 15 is designed such that it automatically adapts the size of the model 16 overlaid in the images 20, 30 if it is necessary based on an association of a point pair so that the selected point pairs can overlap.

If sufficient point pairs are associated so that the model 16 is congruent with the images 20, 30 of the motor block M, it is possible to determine the location of the motor block M relative to the industrial robot 1 (Step S7 of the flow chart).

The calculation of the location ensues as follows in the case of the present exemplary embodiment:

In the case of the present exemplary embodiment, the industrial robot 1 has six degrees of freedom. Moreover, the respective distances between the camera 17 and the motor block M at both positions are unknown. Accordingly, at least four different point pairs must be associated in the two images 20, 30 for the calculation of the location of the motor block M relative to the industrial robot 1.

The location can then be produced with full rank, for example via solving a regular equation system if exactly four different (image) point pairs are present or an overdetermined equation system if more than four point pairs are present, by means of which what is known as a 6 DIF (“6 degrees of freedom”) transformation can be implemented.

The transformation can ensue as follows, for example:

A selected image point Bᵢ can be represented as follows in homogeneous coordinate notation in a two-dimensional coordinate system of the camera 17:

$${B}_{i} = ( \begin{matrix}x \\ y \\ 0 \\ 1\end{matrix} )$$

The model point Pᵢ corresponding to this in the three-dimensional coordinate system of the model 16 can be represented as follows in homogeneous coordinate notation:

$${P}_{i} = ( \begin{matrix}x \\ y \\ z \\ 1\end{matrix} )$$

The transformation matrix for a transformation from a coordinate system of the motor block M into the coordinate system of the first image 20 in the first position of the camera 17 reads:
T₁

and that of the second image 30 in the second position of the camera 17 reads
T₂

The projection matrix for the projection of the coordinates of the i-th image point onto the coordinates of the model 16 reads as follows, for example:

$${Proj}_{i} = [ \begin{matrix}1 & 0 & 0 & 0 \\ 0 & 1 & 0 & 0 \\ 0 & 0 & 1 & 0 \\ 0 & 0 & 1 / {d}_{i} & 0\end{matrix} ] , i = 1 ; 2$$

wherein dᵢ is a camera position-dependent distance parameter of the position of the camera 17 at the i-th position, i.e. dᵢ is the distance parameter associated with the distance between the camera 17 and the motor block M in the first position and d₂ is the distance parameter associated with the distance between the camera 17 and the motor block M in the second position. The distance parameter dᵢ corresponds to the distance between the focal point of the camera 17 and the projection plane (image plane) of the perspective projection

In the case of the present exemplary embodiment, a normalization of the homogeneous coordinate ensues for the further calculation of the location of the motor block M relative to the industrial robot 1, such that the distance parameter dᵢ of the projection matrix Projᵢ receives the value “1”. This can be mathematically expressed as follows:

$$norm ( \vec{k} ) = \frac{\vec{k}}{{k}_{4}}$$

wherein \vec{k} is the vector of the fourth line of the projection matrix Projᵢ and k₄ corresponds to the distance parameter dᵢ.

In the case of the present exemplary embodiment, the location of the motor block M relative to the industrial robot 1 is ultimately implemented [sic] by means of optimization, in particular nonlinear optimization such as, for example, Gauss Newton or Levenberg Marquardt [sic]. For example, the following objective function f(x) is set up for the nonlinear optimization:

$$f ( x ) = {\sum }_{i} ‖ {B}_{i} - norm ( {Proj}_{i} \cdot {T}_{i} ( x ) \cdot {P}_{i} ) ‖$$

with the parameter vector x

$$x = ( \begin{matrix}{T}_{x} \\ {T}_{y} \\ {T}_{z} \\ {R}_{x} \\ {R}_{y} \\ {R}_{z}\end{matrix} )$$

Additional unknown parameters are the distance parameters dᵢ.

In the described exemplary embodiment, exactly two images 20, 30 of the motor block M (thus of an object) were generated. This is not absolutely necessary; more than two images of an object can also be generated.

A pointer device in the form of a computer mouse 13 was used as an input device. Other input devices (for example a space mouse) can also be used for the association of the points 21A, 21B, the points 22A, 22B, the points 31A, 31B and the points 32A, 32B.

Instead of or in addition to an association of points, lines or surfaces of the model 16 can be associated with lines or surfaces in the images of the object.

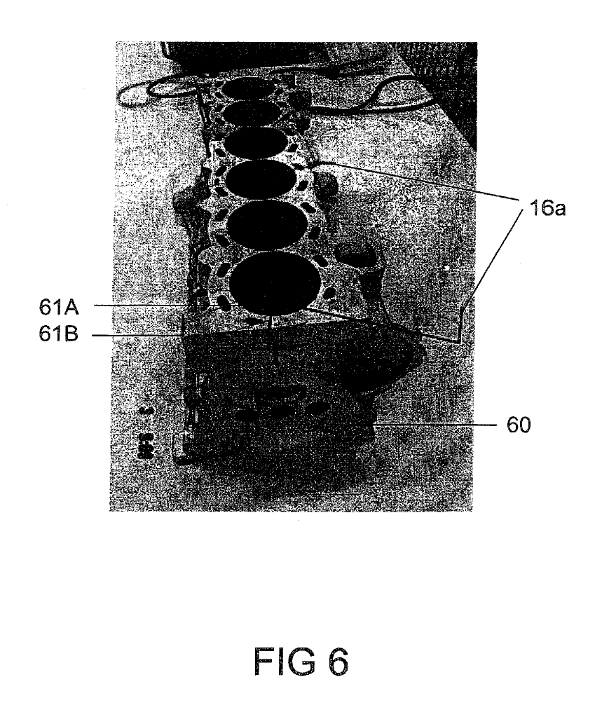

FIGS. 5 and 6 show as an example two images 50, 60 acquired from the two positions by means of the camera 17, in which two positions a model 16a of the motor block M is again overlaid. The image 50 thereby corresponds to the image 20 and the image 60 thereby corresponds to the image 30. The model 16a is likewise a partial wire frame model of the motor block M and, in the case of the present exemplary embodiment, differs slightly from the model 16 of FIGS. 2 and 3.

In the case of the present exemplary embodiment, the person does not select individual points 21A, 22A, 31A, 31A [sic] in the model 16a with the computer mouse 13 but rather selects lines 51A and 52A in the first image 50 and a line 61A in the second image 60. In the case of the present exemplary embodiment, the lines 51A, 52B and 61A correspond to edges 51B, 52B and 61B of the motor block M that the person selects in the images 50, 60.

In order to improve the visibility of the 51B, 52B and 61B in the images 50, 60, in the case of the present exemplary embodiment it is provided to emphasize the edges depicted in the images 50, 60 by means of an image processing algorithm. Suitable image processing algorithms are, for example, edge extraction or Sobel Operator. Detected edges can also be sub-divided into straight-line segments.

In the case of the present exemplary embodiment, a relevant lin [sic] 51A, 52B and 61A in the model 16a is selected with the computer mouse 13 using the “object capture” method known from the CAD world. The selected lin [sic] 51A, 52B, 61A, 62A and 63A is then dragged to the corresponding edges 51B, 52B and 61B in the images 50, 60. The edge 51B, 52B and 61B in the images 50, 60 are identified with the “edge extraction” image data processing method, for example. If a pointer (moved by means of the computer mouse 13) is brought into proximity with such an edge, the “snap-to-line” function known from the CAD world can assist the person.

In contrast to the point association, in line association different degrees of freedom are established (rotation in the image plane, translation along displacement vector).

Although degrees of freedom can no longer be established in the line association, depending on the shape and view of the object it is sometimes more advantageous to bring lines into correspondence than individual points.

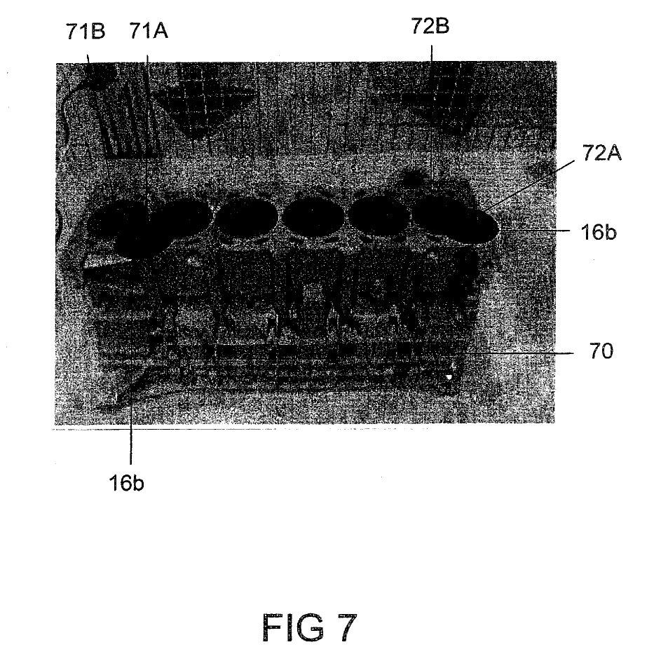

FIG. 7 shows an additional image 70 of the motor block M and a model 16b of the motor block M. In the case of the present exemplary embodiment, the model 16b is a partial model of the motor block M and in particular shows surfaces 71A, 72A that are associated with surfaces 71B and 72B of the motor block M. In the case of the present exemplary embodiment, the surfaces 71B and 72B of the motor block M are recesses of the motor block M.

For the exemplary embodiment shown in FIG. 7, the surfaces 71A, 72A are brought into congruence with the surfaces 71B and 72B shown in image 70 for the calculation of the location of the motor block M relative to the industrial robot 1.

In the exemplary embodiments described up to now, the camera 17 is attached to the flange F of the industrial robot 1. However, the camera 17 can also be attached to one of the axles A1-A6 as long as it is moved by the industrial robot 1.

FIG. 8 shows a further industrial robot 81. If it is not expressly mentioned, functionally identical modules of the industrial robot 1 shown in FIG. 1 are provided with the same reference characters as modules of the industrial robot 81 shown in FIG. 8.

The two industrial robots 1 and 81 are essentially identical. Instead of the camera 17, however, an object 82 whose location (in particular whose orientation) relative to the industrial robot 81 should be determined is attached on the flange F of said industrial robot 81. In order to achieve this, in the case of the present exemplary embodiment a camera 83 is set up on the floor (for example immobile on a tripod 84 relative to the environment of the industrial robot 81) and is connected (in a manner not shown) with the control computer 15 of the industrial robot 81.

The object 81 is subsequently brought into at least two different positions by means of the industrial robot 81, and a 2D image of the object 81 is generated for each position. The images are subsequently displayed on the monitor 14. Moreover, a model of the object 82 overlaid is in the images, and the position of the object 82 relative to the industrial robot 81 is subsequently calculated as for the first exemplary embodiments.

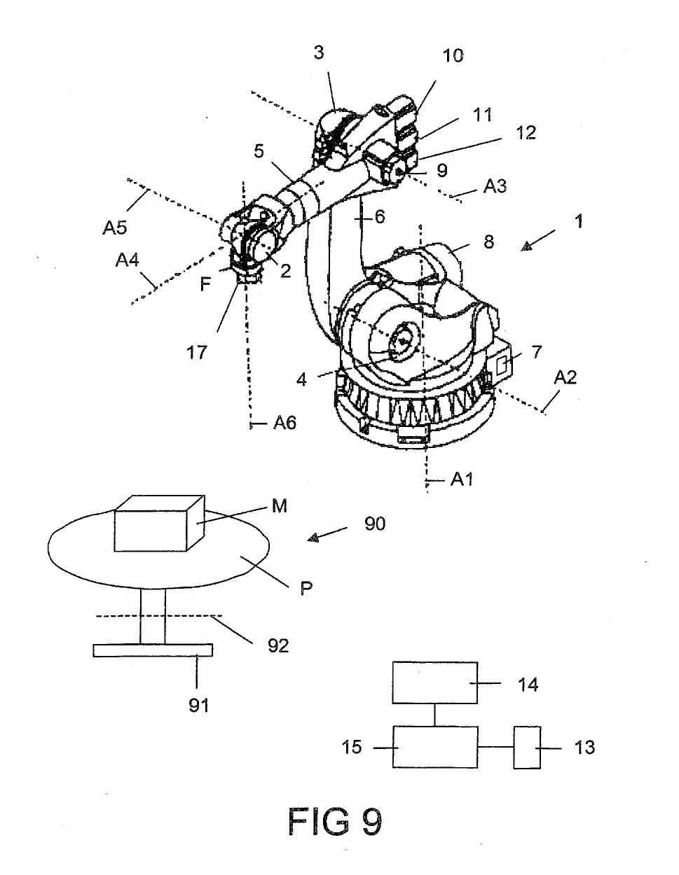

FIG. 9 again shows the industrial robot 1. In contrast to the scenario presented in FIG. 1, in the scenario presented in FIG. 9 the motor block M lies on a table plate P of a table 90.

In the case of the present exemplary embodiment, the table foot 91 of the table 90 can be pivoted relative to an axis 92 by means of a motor (not shown in detail). The motor of the table 90 is connected (in a manner not shown) with the control computer 15 and is also activated by this so that the position of the table plate P relative to the table foot 91 is known. Furthermore, the location of the table 90 or, respectively, of its table foot 91 relative to the industrial robot 1 is known. Information about this location is stored in the control computer 15.

In the case of the present exemplary embodiment, the location of the motor block M on the table plate P is initially unknown since the motor block M was essentially arbitrarily placed on the table plate P. In order to determine the location of the motor block M relative to the industrial robot 1, the location of the motor block M relative to the table plate P is initially determined. If this is established, the location of the motor block M relative to the industrial robot 1 can then also be determined since the position of the table plate P relative to the table foot 91 and the location of the table foot 91 relative to the industrial robot 1 are known.

In order to determine the location of the motor block M relative to the table plate P, images are acquired with the camera 17 from two different positions. The two positions result via a movement of the industrial robot 1 or, respectively, its flange F and/or via a pivoting of the table plate P relative to the axis 92.

The model 16 of the motor block M is subsequently overlaid in the acquired images and points of the model 16 are associated with points of the image of the motor block M. Based on this association, which is implemented analogous to the association of the point pairs shown in FIGS. 2 and 3, the location of the motor block M relative to the table plate P can subsequently be calculated. This calculation is implemented analogous to the calculation of the location of the motor block M relative to the industrial robot 1 according to the scenario shown in FIG. 1.

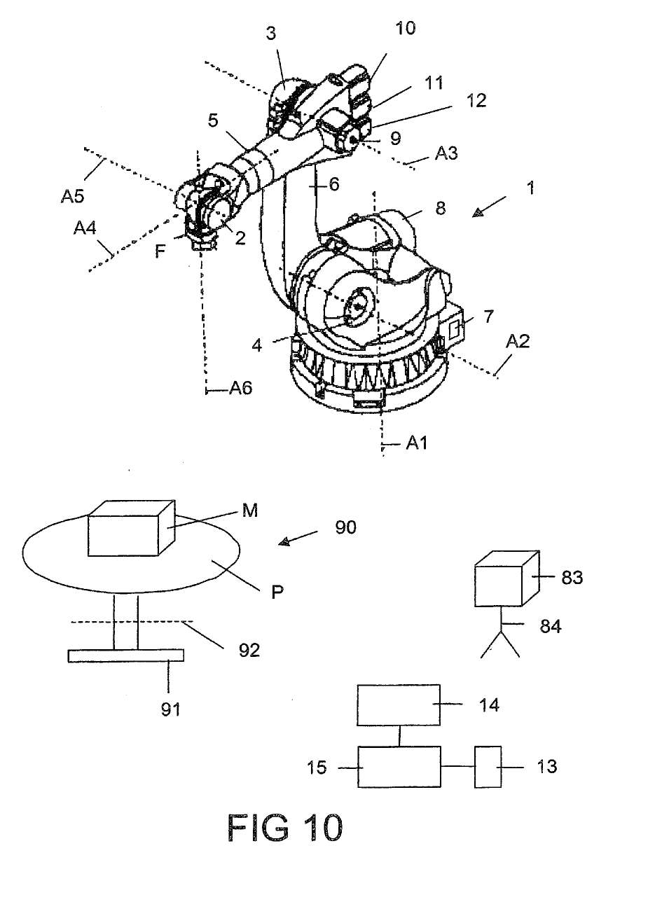

Alternatively, the camera can also be mounted stationary on a tripod 84, similar to the scenario shown in FIG. 8. Such a scenario is shown in FIG. 10, in which the camera has the reference character 83. Two different positions for which the camera 83 acquires images of the motor block M can be set via pivoting of the table plate P on the axis 92. The location of the motor block M relative to the table plate P can subsequently be determined according to the scenario shown in FIG. 9.

1. Method to determine the location of an industrial robot relative to an object, possessing the following method steps:
movement of a 2D camera (17) attached to an industrial robot (1) into at least two different positions by means of said industrial robot,
in each of the positions, generation by means of the camera (17) of a two-dimensional image data set associated with an image (20, 30, 50, 60, 70) of an object (M), wherein the object (M) is immobile relative to the environment of the industrial robot (1),
display of the images (20, 30, 50, 60, 70) by means of a display device (14) and superimposition of a graphical model (16, 16a, 16b) in the displayed images (20, 30, 50, 60, 70), wherein the graphical model (16, 16a, 16b) is at least a partial model of the object (M) and is described in coordinates relative to coordinates of the industrial robot (1),
manual association of model points (21A, 22A, 31A, 32A) of the graphical model (16) with corresponding image points (21B, 22B, 31B, 32B) in the two images (20, 30) and
determination of the location of the industrial robot (1) relative to the object (M) based on the associated model points (21A, 22A, 31A, 32A) of the model (16) at the corresponding image points (21B, 22B, 31B, 32B) in the images (20, 30), the positions of the camera (17) that are associated with the images (20, 30) and the position of the camera (17) relative to the industrial robot (1).

2. Method to determine the location of an industrial robot relative to an object, possessing the following method steps:
generation of a respective two-dimensional image data set with a 2D camera (17, 83) for two different positions, wherein the image data sets are associated with images of an object (M), the object (M) is arranged on a table plate (P) that is movable relative to a reference point that is immobile relative to the environment of the industrial robot (1), and the camera (17, 83) is attached to the industrial robot (1) or is immobile relative to a base coordinate system of the industrial robot (1), wherein the table plate (P) and/or the industrial robot (1) are moved for both positions,
display of the images by means of a display device (14) and overlay of a graphical model in the displayed images, wherein the graphical model is at least a partial model of the object (M) and is described in coordinates relative to coordinates of the industrial robot (1),
manual association of model points of the graphical model with corresponding image points in the two images,
determination of the location of the object (M) relative to the table plate (P) based on the associated model points of the model with the corresponding image points in the images, the location of the reference point of the table plate (P) relative to the industrial robot (1) and the position of the camera (17, 83) relative to the industrial robot (1) and
determination of the location of the industrial robot (1) relative to the object (M) based on the location of the object relative to the table plate.

3. Method according to claim 1 or 2, in which the camera (17) is attached to a flange (F) or an axle (A1-A6) of the industrial robot (1).

4. Method to determine the location of an industrial robot relative to an object, possessing the following method steps:
movement of an object (82) attached to an industrial robot (81) into at least two different position [sic] by means of the industrial robot (81),
in each of the positions, generation by means of a 2D camera (83) of a two-dimensional image data set associated with an image of an object (82), which 2D camera is immobile relative to a base coordinate system of the industrial robot (81),
display of the images by means of a display device (14) and superimposition of a graphical model in the displayed images, wherein the graphical model is at least a partial model of the object (82) and is described in coordinates relative to coordinates of the industrial robot (81),
manual association of model points of the graphical model with corresponding image points in the two images and
determination of the location of a flange of the industrial robot (1) relative to the object (82) or of the location of the camera (83) relative to the industrial robot (81) based on the associated points of the model at the corresponding points in the images, the positions of the object (82) that are associated with the images and the position of the camera (83) relative to the base coordinate system of the industrial robot (81).

5. Method according to claim 4, in which the object (82) is attached to a flange (F) of the industrial robot (81).

6. Method according to any of the claims 1 through 5, possessing:
manual association of a first model point (21A) of the model points of the model (16) with a corresponding first image point (21B) of one of the two images (20),
displacement of the model (16) overlaid in the images (20,30) so that the first model point (21A) and the first image point (21B) correspond,
locking the two corresponding first model and image points (21A, 21B),
manual association of a second model point (22A) of the model points of the model (16) with a corresponding second image point (22B) of one of the two images (20),
displacement of the model (16) overlaid in the images (20, 30) so that the second model point (22A) and the second image point (22B) likewise correspond,
locking the two corresponding second model and image points (22A, 22B) and
manual association of additional individual model points (31A, 32A) of the model (16) with corresponding image points (31B, 32B) in the images (30) until the location of the industrial robot (1) relative to the object (M) can be determined.

7. Method according to any of the claims 1 through 6, also possessing an automatic size adaptation of the overlaid model (16) based on a manual association of at least two different model points.

8. Method according to any of the claims 1 through 7, possessing
manual association of lines (51A, 52A, 61A) and/or surfaces (51A, 52A, 61A) of the model (16a, 16b) can also be manually associated with corresponding lines (51B, 52B, 61B) or, respectively, surfaces (71B, 72B) in at least one of the images (50, 60, 70) or
manual association of lines (51A, 52A, 61A) and/or surfaces (51A, 52A, 61A) of the model (16a, 16b) can also be manually associated with corresponding lines (51B, 52B, 61B) or, respectively, surfaces (71B, 72B) in the images (50, 60, 70) instead of the image points and model points.

9. Method according to any of the claims 1 through 7, in which the model (16, 16a) is a graphical wire frame model or a graphical partial wire frame model of the object (M).

10. Industrial robot possessing
multiple axles (A1-A6) movable by means of actuators (7-12),
a control device (15) to activate the actuators (7-12),
a 2D camera (17) to generate a two-dimensional image data set, wherein the camera (17) is attached at the industrial robot (1) such that it can be moved by the industrial robot (1),
a graphical model (16, 16a, 16b) stored in the control device (15), which graphical model is at least a partial model of an object (M) and is described in coordinates relative to coordinates of the industrial robot (1),
a display device (16 [sic]) to display images (20, 30, 50, 70, 60) associated with image data sets generated with the camera, and to overlay the model (16, 16a, 16b) in the displayed images (20, 30, 50, 60, 70) and
an input device (13) for manual association of points (21A, 22A, 31A, 32A) of the graphical model (16, 16a, 16b) with points (21B, 22B, 31B, 32B) in the images (20, 30)
wherein the industrial robot (1) is set up such that the method according to any of the claims 1 through 3 or 6 through 9 can be implemented with it in order to determine the location of the object (M) relative to the industrial robot (1) when the object (M) is arranged immobile relative to the environment of the industrial robot (1) or on a table plate (P) that can be moved relative to a reference point that is immobile relative to the environment of the industrial robot (1).

11. Industrial robot possessing
multiple axles (A1-A6) movable by means of actuators (7-12),
a control device (15) to activate the actuators (7-12),
a 2D camera (17) to generate a two-dimensional image data set, wherein the camera (83) is immobile relative to a base coordinate system of the industrial robot (81),
a graphical model stored in the control device (15), which graphical model is at least a partial model of an object (82) and is described in coordinates relative to coordinates of the industrial robot (81),
a display device (14) to display images associated with image data sets generated with the camera (17), and to overlay the model in the displayed images and
an input device (13) for manual association of points of the graphical model with points in the images,
wherein the industrial robot (81) is set up such that the method according to any of the claims 5 through 9 can be implemented with it in order to determine the location of the physical object (82) relative to the industrial robot (81) when the physical object (82) is attached to the industrial robot (81) and can be moved by means of this.
